(19) United States
(12) Patent Application Publication
(10) Pub. No.: US 2025/0353326 A1
(43) Pub. Date: Nov. 20, 2025

(54) WHEEL HUB FOR A VEHICLE AND METHOD FOR ADAPTING A FLANGE OF A WHEEL HUB OF A VEHICLE TO AN OPERATING CONDITION OF THE VEHICLE

(71) Applicant: AKTIEBOLAGET SKF, GOTEBORG (SE)

(72) Inventors: Marc SCHOLLMEYER, St. Albans (GB); Richard CORBETT, Fondettes (FR)

(21) Appl. No.: 19/200,066

(22) Filed: May 6, 2025

(30) Foreign Application Priority Data
May 15, 2024 (DE) 102024204477.6

(51) Int. Cl. B60B 27/00

(52) U.S. Cl. CPC B60B 27/0078; B60B 27/0005

(57) ABSTRACT

A wheel hub for a vehicle includes a flange configured to be connected to at least one wheel of the vehicle with at least one fastening device. The flange is provided with at least one reinforcing element that increases stiffness of the flange in a predetermined area, the predetermined area being determined based on intended operating conditions of the vehicle.

### CROSS-REFERENCE

This application claims priority to German patent application no. 102024204477.6 filed on May 15, 2024, the contents of which are fully incorporated herein by reference.

### BACKGROUND OF THE INVENTION

The present invention relates to a wheel hub for a vehicle, and a method for adapting a flange of a wheel hub of a vehicle to an operating condition of the vehicle.

Wheel hubs are used to connect a wheel to a vehicle and usually include a flange to which the wheel can be connected directly or indirectly, for example by means of an adapter. A contact area between the flange and the component attached thereto, namely the wheel or the adapter, needs to be as large as possible in order to support the forces resulting from the attachment of the component, such as axial clamping forces, as well as any loads and/or forces acting on the wheel. These loads and/or forces typically depend on the conditions under which the vehicle is operated.

Although the contact area between the flange and the component attached to the flange may seem to be sufficiently large, the loads and/or forces acting on the flange and the wheel during operation may cause deformations and/or bending of the flange and/or the part of the wheel that is in contact with the flange. The deformations and/or the bending of the components in contact with each other can lead to a reduced contact area between connected components. Such a reduced contact area may then lead to vibration, fretting, and the like, which may lead to a reduced service life as well noise caused by relative movement of the contacting parts. Moreover, the deformations, the bending and/or any relative movement may be transferred to other parts that connected with the wheel hub, such as a bearing that supports rotation of the wheel. As such, the reduced contact area may also lead to reduced service life of adjacent parts.

### SUMMARY OF THE INVENTION

It is therefore object of the present invention to optimize an area of contact between a flange of a wheel hub and a wheel attached thereto under operating conditions.

This object is solved by a wheel hub for a vehicle comprising a flange configured to be connected to at least one wheel of the vehicle with at least one fastening means.

To optimize an area of contact between the flange and the wheel attached thereto, particularly under expected operating conditions of the vehicle, the flange is provided with at least one reinforcing element that increases a stiffness of the flange within a predetermined area. Preferably, the predetermined area is determined based on operating conditions of the vehicle.

The vehicle may be a car, a truck, a train, an airplane, a motorcycle, trailer, or the like. Moreover, the wheel may be directly or indirectly attached to the flange, namely by means of another component. For example, the wheel may be attached to the flange by a wheel rim. Alternatively, the wheel rim may be attached to a wheel adapter, the adapter being directly attached to the flange. Also, the wheel may be a driven wheel, namely a wheel that is coupled to a drive train of the vehicle, or an undriven wheel, for example a wheel of a trailer.

The flange may be connected to, or may be part of, a bearing supporting the rotation of the wheel. For example, a wheel hub assembly comprising a bearing unit having at least one first bearing ring, at least one second bearing ring and at least one set of rolling elements arranged between the at least one first bearing ring and the at least one second bearing ring, wherein the first bearing ring includes the flange. The first bearing ring may be a rotating bearing ring and the second bearing ring may be a stationary ring. Depending on the type of bearing unit, the rotating bearing ring may be an outer ring or an inner ring. Furthermore, the rolling elements may be any type of rolling element, such as balls, tapered roller, cylindrical rollers, needle roller, spherical rollers, and the like. Also, the bearing unit may include a single set of rolling element or two or more sets of rolling elements.

The operating conditions may depend on a weight of the wheel attached to the flange, and/or a size of the wheel attached to the flange. The weight and/or size of the wheel may depend on the type, size, and/or material of the rim of the wheel and/or the wheel adapter. Furthermore, the operating conditions may depend on the forces acting on the wheel such as gravity, centrifugal forces, acceleration forces, braking forces, cornering forces, forces transmitted by a suspension element of the vehicle. Also, the operating conditions may depend on a track or road the vehicle follows. For example, if the car is a race car, the operating conditions may depend on the structure of a racetrack. More specifically, the different types of tracks or roads may result in different forces acting on the wheel hub. Thus, different tracks may create different operating conditions for a particular wheel hub.

Moreover, the stiffness may be increased by the reinforcement element such that a bending moment on the flange induced by a load is below a predefined threshold. This allows for an increase in the stiffness of the flange in the areas that are most affected by the operating conditions. In particular, the load acting on the flange may depend on the operating conditions. Since the areas that are most affected by the loads acting on the flange are reinforced with the at least one reinforcement element, it is also possible to reduce the material and/or size of the flange in parts that are not affected or only slightly affected.

Preferably, the load acting on the flange under expected operating conditions is determined by measuring the load and/or the at least one force acting on the flange. In particular, a test wheel hub equipped with sensors, such as strain sensors, acceleration sensors, load sensors, etc. may be used to determine loads and/or forces occurring under the operating conditions. That is, the load and/or the at least one force acting on the flange may be determined under the same operating conditions to which the vehicle will be subjected. For example, if the vehicle is moving on a predefined track, the operating conditions may be determined by operating the same vehicle on the predefined track, or if a wheel attached to the wheel hub has a different size and/or weight, the operating conditions may be determined by operating the vehicle with such a different wheel.

Alternatively, the load acting on the flange under the operating conditions may be computed based on predetermined data of the vehicle, the wheel, and/or an operating condition(s). By determining the load acting on the flange, it is possible to adapt a position and/or a size and/or material of the reinforcement element to any changes in the operating condition. For example, a thickness of the at least one reinforcement element in a direction of the normal vector of the flange surface may be between 0.01 μm and 500 μm. This increases the stiffness of the flange without excessively changing an evenness of the contact surface.

The bending moments induced in the flange may be determined by using a computational method, such as finite element method, or any other method that allows computation of bending moments induced in a component by the loads and/or forces acting on the component. Alternatively, the magnitude of the bending moments may be obtained using a suitable sensor. To obtain an area of contact between the wheel and the flange that is as large as possible under the operating conditions, it is advantageous, if even under the maximal load occurring during the operating conditions, to maintain the induced bending moments below a predetermined threshold.

The predetermined threshold may relate to an absolute value of a bending moment induced in the flange or a relative value, such as a ratio of the lowest bending moment to the highest bending moment, or a difference between the highest bending moment and the lowest bending moment. By identifying the area or areas of the flange in which the induced bending moments exceed the predetermined threshold, it is possible to locally reinforce the flange with the at least one reinforcement element such that the bending moment induced by the determined load is below the predefined threshold in the predetermined area under the operating conditions. Adding material in a region that experiences higher bending moments may provide the advantage of increasing the stiffness of the flange in that region, such that the resulting bending moments may decrease.

Furthermore, the at least one reinforcement element is arranged or located in an area of the at least one fastening means. Since the area in which the at least one fastening means is fastened to the flange may be subjected to a higher load compared to other areas of the flange, it may be advantageous to arrange the at least one reinforcement element proximal to the at least one fastening element. This may maintain the resulting bending moment below a predetermined threshold. For example, the flange may be provided with at least one hole into which the fastening means can be inserted. Alternatively, the flange may be provided with at least one bolt by which the wheel can be attached.

Also, the flange may include at least one contact surface configured to be connected to the wheel, wherein the at least one reinforcement element is located at the contact surface. By arranging the at least one reinforcement element at the contact surface of the flange, the stiffness of the flange may be increased in the area where the bending moments are induced.

Preferably, the wheel hub may comprise a plurality of reinforcement elements that are arranged such that a variation in a magnitude of the bending moments over the entire flange is minimized. The plurality of reinforcement elements may modify a topology of the flange such that the bending moment induced by the determined load is below the predefined threshold in the determined area under the operating conditions. This may keep the area of contact between the wheel and the flange under the operating conditions as large as possible. For example, the topology may resemble a distribution of the bending moments induced in the flange under the operating conditions.

Moreover, at least one reinforcement element of the plurality of reinforcement elements may differ in height and/or thickness from the remaining reinforcement elements. This enables adaptation of the stiffness of the flange to the loads and/or forces acting on the flange due to the operating conditions. More specifically, a reinforcement element having a greater thickness and/or a greater height may increase the stiffness of the flange in a predetermined area more than a reinforcement element having a lesser thickness and/or a lesser height. In particular, the terms “height of the reinforcement element” and “thickness of the reinforcement element” may each refer to a dimension of the reinforcement element in the direction of the normal vector of the contact surface of the flange.

In addition, the wheel hub may further comprise a washer, wherein the washer includes or provides the least one reinforcement element. This enables the reinforcement element to be provided on a separate element. A separate washer comprising the at least one reinforcement element may enable adapting the topology and/or the stiffness in an easy and fast manner if the operating condition changes. For example, a set of different washers may be manufactured for a predetermined set of different operating conditions. This may allow adapting the wheel hub to changes in the size and/or weight of the wheel, or changes in the expected forces acting on the wheel and/or flange, in an easy and fast way. Also, if the wheel hub is used in a vehicle that runs on a predefined track, it may be possible to provide a washer that is adapted to the specific loads and/or forces occurring on the predefined track.

Preferably, the washer may be fixed to flange by form-fitting, force-fitting and/or bonding. For example, the washer may be attached to the flange by glueing, welding, screwing, bolting, and/or pressing or any other suitable fastening method. By attaching the washer to the flange, any relative movement between the flange and the washer may be reduced or even prevented. This ensures that the at least one reinforcement element is arranged in the predetermined area to increase the stiffness in the area.

Furthermore, the at least one reinforcement element may be attached to the flange and/or the washer by form-fitting, force-fitting and/or bonding. For example, the at least one reinforcement element may be attached to the flange and/or the washer by glueing, welding, screwing, bolting, and/or pressing or any other suitable fastening method. By attaching the at least one reinforcement element to the flange and/or washer, any relative movement between the at least one reinforcement element, the flange and/or the washer may be reduced or even prevented. This ensures that the at least one reinforcement element is arranged in the predetermined area to increase the stiffness in the area.

Moreover, the at least one reinforcement element may be integrally formed with the flange of the wheel hub and/or a washer. In other words, the at least one reinforcement element may be a part of the flange and/or the washer. Thus, the at least one reinforcement element may be directly formed on a surface of the flange and/or washer by adding and/or removing of material to create a modified topology of the contact surface. The at least one reinforcement element on the washer and/or flange may be formed by machining, 3D-printing, additive manufacturing, and/or laser-cladding. In particular, machining, 3D-printing, additive manufacturing, and/or laser-cladding enables precise manufacturing of a surface having at least one reinforcement element. For example, the at least one reinforcement element may be an elevated region on the washer and/or the flange.

Also, the at least one reinforcement element and/or washer may be made from a material different from the material of the flange. For example, the at least one reinforcement element and/or the washer may be made from metal, such as steel, steel alloy, light metal, light alloy, carbon, and/or fiber reinforced materials. By using a different material for the at least one reinforcement element and/or the washer, the stiffness of the flange may be adapted to the induced bending moments. Alternatively, the at least one reinforcement element and/or the washer may be made from the same material as the flange.

According to a further aspect of the invention, a method for adapting a flange of a wheel hub of a vehicle to an operating condition of the vehicle is provided. The flange is configured to be connected to at least one wheel of the vehicle with at least one fastening means. The method comprises the following steps:
determining an area where a load acting on the flange under the operating condition(s); and
adding at least one reinforcement element to the flange in the determined area for increasing the stiffness of the flange.

Moreover, the method may further comprise determining a bending moment induced in the flange based on the determined load, determining an area of the flange, in which the determined bending moment is above a predefined threshold, and adding the at least one reinforcement element in the determined area.

In particular, the at least one reinforcement element may be added to an area of the flange that experiences higher bending moments. By adding or removing material for the contact surface, the stiffness of the flange, and therefore the induced bending moments, can be adapted to the predetermined operating conditions. This keeps an area of contact between the flange and the wheel as large as possible, which can lead to an increased service life of the wheel hub and/or components attached to the wheel hub, such as bearing units.

Furthermore, the method may further comprise adapting a topology of the flange such that the bending moment induced by the determined load is below a predefined threshold in the determined area under the operating condition. Preferably, the at least one reinforcement element is added to an area such that a variation of the magnitude of the bending moments over the entire flange is minimized. This enables achievement of a uniform and/or homogenous load and/or stress distribution over the entire flange such that a bending and/or warping of the flange under the operating condition is minimized. Further, the reinforcement element also maintains an area of contact between the wheel and the flange as large as possible during the operating conditions, a reduction in vibrations and/or noise, and an increases in the service life of the bearing assembly.

By adding a plurality of reinforcement elements, a topology of a contact surface between the flange and the wheel may be modified. Modifying the thickness of the flange by adding at the at least one reinforcement element has the advantage that the topology can be directly adapted by adding material.

An even further aspect of the present invention relates to a computer program product comprising a computer program code which is adapted to prompt a control unit, e.g., a computer, and/or a computer of the above discussed manufacturing arrangement to perform the above discussed steps. In particular, the computer program code may be configured to determine an area in which a load acts on the flange under the operating conditions and/or a bending moment induced in the flange based on a determined load and/or an area of the flange in which the determined bending moment is above a predefined threshold.

The computer program product may be a provided as memory device, such as a memory card, USB stick, CD-ROM, DVD and/or may be a file which may be downloaded from a server, particularly a remote server, in a network. The network may be a wireless communication network for transferring the file with the computer program product.

Further preferred embodiments are defined in the dependent claims as well as in the description and the figures. Thereby, elements described or shown in combination with other elements may be present alone or in combination with other elements without departing from the scope of protection of the present invention.

### BRIEF DESCRIPTION OF THE SEVERAL VIEWS OF THE DRAWINGS

In the following, preferred embodiments of the invention are described in relation to the drawings, wherein the drawings are exemplary only, and are not intended to limit the scope of protection. The scope of protection is defined by the accompanied claims, only. The figures show:

FIG. 1 is a wheel hub assembly for a vehicle having a wheel hub according to a first embodiment;

FIG. 2 is a top view of a flange of the wheel hub of FIG. 1;

FIG. 3 is a cross section taken along the line III-III in FIG. 2;

FIG. 4 is a wheel hub assembly for a vehicle having a wheel hub according to a second embodiment;

FIG. 5 is a top view of the wheel hub of FIG. 4; and

FIG. 6 is a cross section taken along the line VI-VI in FIG. 5,

### DETAILED DESCRIPTION OF THE INVENTION

In the following same or similar functioning elements are indicated with the same reference numerals.

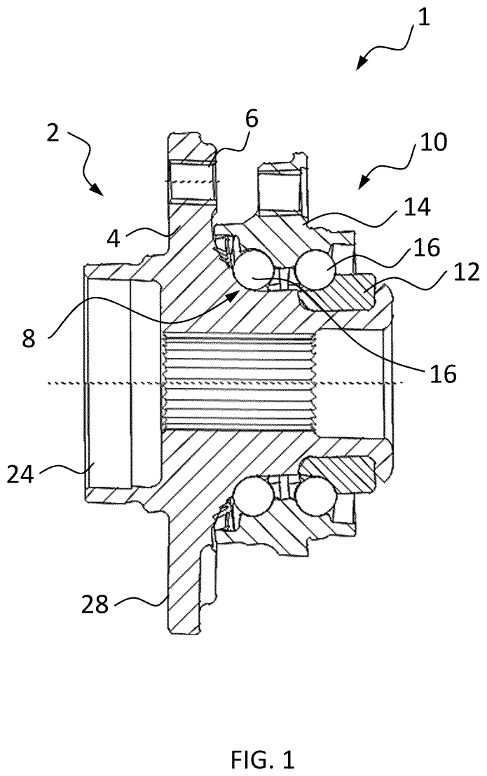

With reference to FIGS. 1-3, a wheel hub assembly 1 for a vehicle (not shown) is shown comprising a wheel hub 2 according to a first embodiment. The wheel hub 2 has a flange 4 configured to be connected to at least one wheel (not depicted) of the vehicle by at least one fastening means (not shown). The vehicle may be a car, a truck, a train, an airplane, a motorcycle, trailer, or the like. Moreover, the wheel may be attached to the flange 4 directly or indirectly, namely via a further component. For example, the wheel may be attached to the flange by a wheel rim. Alternatively, the wheel rim may be attached to a wheel adapter which is then attached to the flange 4. Also, the wheel may be a driven wheel, namely a wheel that is coupled to a drive train of the vehicle, or an undriven wheel, for example a wheel of a trailer.

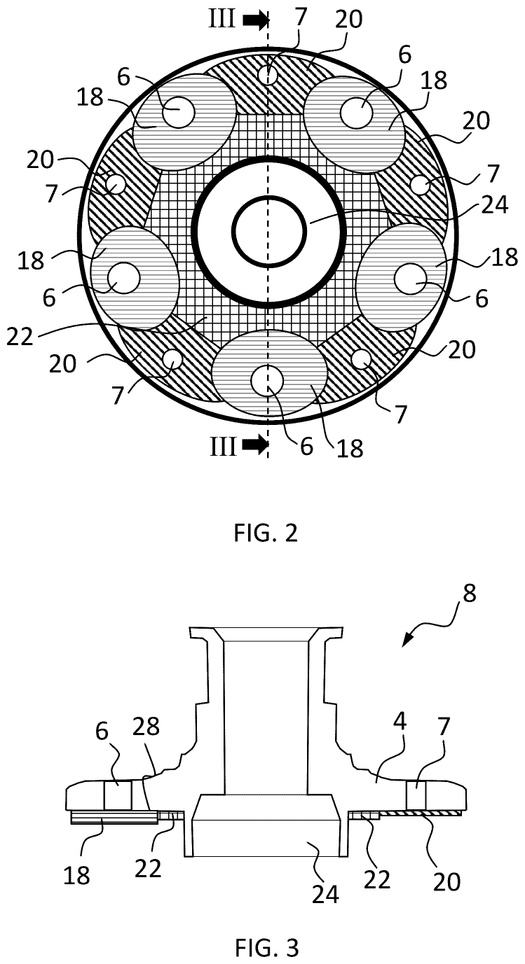

The at least one fastening means may be a bolt or a screw which can be inserted into a threaded hole 6 provided in the flange 4. Preferably, the flange 4 is provided with a plurality of the holes 6, the particular number of the holes 6 may depend on a size of the vehicle and/or wheel. For example, the wheel hub assembly 1 of the first embodiment includes five (5) of the holes 6, as can be seen in FIG. 2. It is also possible to use more fastening elements, for example six or even more than six, or less fastening elements, for example four or even only one, for fastening the wheel to the wheel hub 2.

Alternatively, the flange 4 may be provided with bolts, such as integral studs, that serve as fastening means for fastening the wheel to the flange 6. In addition to the holes 6 for fastening the wheel to the flange 4, the flange 4 is preferably also provided with smaller holes 7 (see FIG. 2) that may be used to fasten a brake disc to the flange 4. Depending on the type of the brake disc, these smaller holes 7 may be omitted.

The wheel hub assembly 1 further comprises a bearing unit 10 having a first inner ring 8 and a second inner ring 12, an outer ring 14 and two set of rolling elements 16 arranged in two rows between the inner rings 8, 12 and the outer ring 14. Preferably, the inner rings 8, 12 are rotatable and the outer ring 14 is stationary. Furthermore, the rolling elements 16 in the exemplary embodiment are shown as balls. However, the rolling elements 16 may be any type of rolling elements, such as tapered rollers, cylindrical rollers, needle rollers, spherical rollers, and the like. Although the bearing unit 10 is shown with two sets of rolling elements 16, the bearing unit 10 may alternatively comprise a single set of rolling element 16 or more than two sets of rolling elements 16. In the embodiment shown in FIGS. 1-3, the flange 4 is integrally formed with the first inner ring 8 of the bearing unit 10. Alternatively, the flange 4 may be separate from the bearing unit 10.

Since the wheel is connected to the flange 4, any loads and/or forces acting on the wheel are transmitted to the flange 4. Furthermore, the loads and/or forces acting on the wheel and/or flange 4 depend on an operating condition(s) under which the vehicle is operated. For example, the operating conditions may depend on a weight of the wheel attached to the flange 4, and/or a size of the wheel attached to the flange 4. The weight and/or size of the wheel may depend on the type, size, and/or material of the rim of the wheel and/or the wheel adapter. Furthermore, the operating conditions may depend on the forces acting on the wheel such as gravity, centrifugal forces, acceleration forces, braking forces, cornering forces, forces transmitted by a suspension element of the vehicle. Also, the operating conditions may depend on a track the vehicle follows. For example, if the car is a race car, the operating condition may depend on the structure of a specific racetrack. Different tracks may result in different forces acting on the wheel hub, e.g., greater or lesser banks or slopes. Thus, different racetracks may create different expected operating conditions on the wheel hub assembly 1.

To optimize an area of contact between the flange 4 and the wheel attached thereto, particularly under operating conditions of the vehicle, the flange 4 is provided with a plurality of reinforcing elements 18, 20, 22 (FIGS. 2-3) that modify a topology of the flange 4. In particular, the plurality of reinforcement elements 18, 20, 22 may increase a stiffness of the flange 4 in predetermined areas, which are determined based on the anticipated operating conditions of the vehicle. This may enable limiting a bending moment on the flange 4, induced by a load, to a predefined threshold or less.

Please note that, in the drawing figures, the dimensions of the reinforcement elements 18, 20, 22, particularly a thickness thereof, are exaggerated for visualization purposes.

The plurality of reinforcement element 18, 20, 22 are located at a contact surface 28 of the flange 4, where the flange 4 and the wheel are in contact with another. As can be seen in FIG. 2, the reinforcement elements 18 are arranged around the holes 6 that are configured to interact with the fastening means for attaching the wheel to the flange 4. Furthermore, the reinforcement elements 20 are arranged in the areas of the holes 7 and the reinforcement element 22 is arranged at a central opening 24 in the wheel hub 2.

As can be seen in FIG. 3, the different reinforcement elements 18, 20, 22 differ in their respective extension or dimension in the direction of the normal vector of the flange 4. For example, the reinforcement elements 18 are thicker than the reinforcement elements 20 and 22. Generally, a reinforcement element 18, 20, 22 having a greater thickness or extension in the direction of the normal vector of the flange 4 may increase the stiffness of the flange 4 in the area in which the reinforcement element is arranged more than a “thinner” reinforcement element. Thus, by adapting a thickness of the reinforcement elements 18, 20, 22, the stiffness of the flange 4 can be adapted to the loads and/or forces acting on the flange 4 due to the operating condition. For example, a thickness of a reinforcement element 18, 20, 22 may be between 0.01 μm and 500 μm. This increases the stiffness of the flange 4 without excessively changing an evenness of the contact surface 28.

The position and/or the respective thicknesses of the reinforcement elements 18, 20, 22 are selected such that a variation in a magnitude of the bending moments over the entire flange 4 is minimized. The plurality of reinforcement elements 18, 20, 22 may modify the topology of the flange 4 such that the bending moments induced by the loads acting on the flange 4 is below a predefined threshold.

In the first embodiment, the reinforcement elements 18, 20, 22 are integrally formed with the flange 4. In other words, the reinforcement elements 18, 20, 22 are directly formed on the contact surface 28 of the flange 4 by adding and/or removing of material to create a modified topology of the contact surface 28. For example, the reinforcement elements 18, 20, 22 on the contact surface 28 of the flange 4 may be formed by machining, 3D-printing, additive manufacturing, and/or laser-cladding. In particular, the flange 4 may be manufactured with a topology that is modified by the reinforcement elements 18, 20, 22.

Alternatively, the reinforcement elements 18, 20, 22, or only a part of the reinforcement elements 18, 20, 22, may be attached to the flange 4 by form-fitting, force-fitting and/or bonding. For example, the reinforcement elements 18, 20, 22 may be attached to the flange 4 by glueing, welding, screwing, bolting, and/or pressing or any other suitable fastening method.

To determine the positions and/or dimensions and/or number of the reinforcement elements 18, 20, 22, the load acting on the flange 4 under the expected operating conditions is determined by measuring the load and/or the at least one force acting on the flange 4. In particular, a test wheel hub 2 equipped with sensors, such as strain sensors, acceleration sensors, etc., may be used to determine loads and/or forces occurring under the operating conditions. That is, the load and/or the at least one force acting on the flange 4 may be determined under the same operating conditions the vehicle will be subjected to.

For example, if the vehicle is moving on a predefined track, the operating conditions may be determined by operating the same vehicle on the predefined track or if a wheel is attached to the wheel hub having a different size and/or weight, the operating conditions may be determined by operating the vehicle with the different wheel. Alternatively, the load acting on the flange 4 under the operating conditions may be calculated based on predetermined data of the vehicle, the wheel, and/or the operating conditions. After determining the load acting on the flange 4, the bending moments induced in the flange 4 may be determined using a computational method such as finite element method, or any other method that allows computation of bending moments induced in a component by loads and/or forces acting on the component. To obtain an area of contact between the wheel and the flange 4 that is as large as possible under the operating conditions, it is advantageous, if even under the maximal load occurring during the operating conditions, to maintain induced bending moments below a predetermined threshold.

The predetermined threshold may relate to an absolute value of a bending moment induced in the flange 4 or a relative value, such as a ratio of the lowest bending moment to the highest bending moment, or a difference between the highest bending moment and the lowest bending moment. By identifying the area or areas of the flange 4 in which the induced bending moments exceed the threshold, it is possible to locally reinforce the flange 4 with the at least one reinforcement element 18, 20, 22 such that the bending moment induced by the determined load is below the predefined threshold in the predetermined area under the operating conditions. Adding material in a region that experiences higher bending moments may have the advantage of increasing the stiffness of the flange 4 in that region such that the resulting bending moments are decreased.

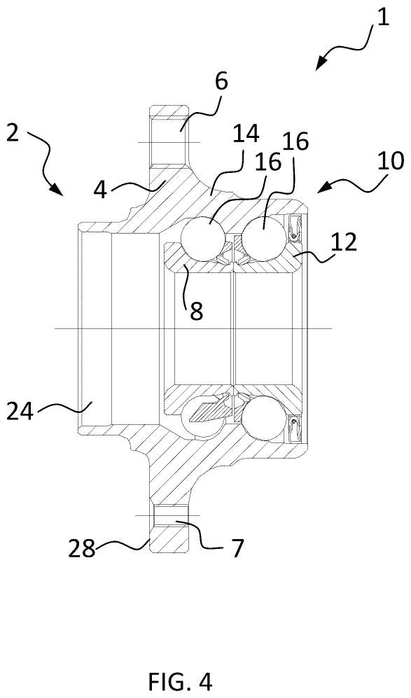

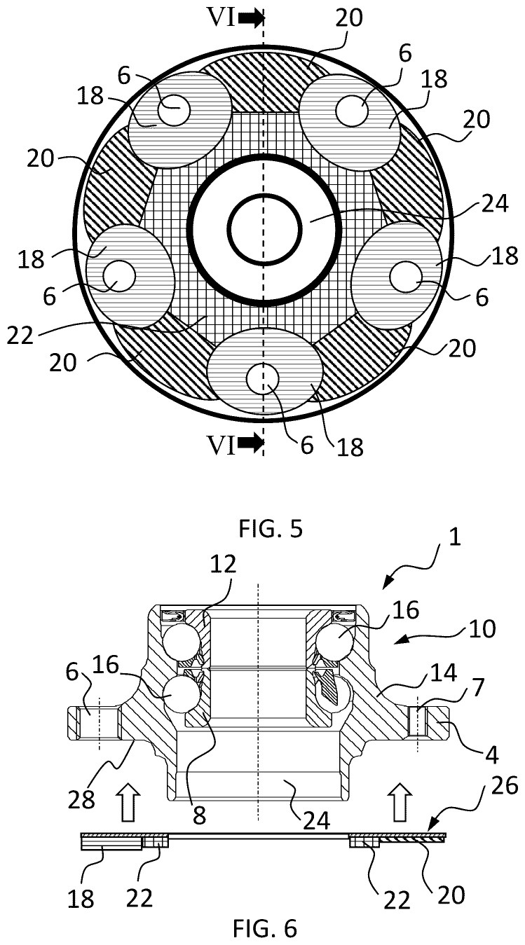

With reference to FIGS. 4-6, a wheel hub assembly 1 for a vehicle (not shown) is shown comprising a wheel hub 2 according to a second embodiment. The wheel hub assembly 1 of FIG. 4 differs from the wheel hub assembly of FIG. 1 in that the outer ring 14 is a rotatable ring and the inner rings 8, 12 are stationary. Furthermore, wheel hub 2 of the second embodiment is connected to the rotating outer ring 14 instead of the first inner ring 8.

Please note that, in the drawing figures, the dimensions of the reinforcement elements 18, 20, 22, particularly a thickness, are exaggerated for visualization purposes.

Also, the reinforcement elements 18, 20, 22 are each provided on a separate washer 26. The separate washer 26 has the advantage that the topology and/or the stiffness of the flange 4 can be adapted in an easy and fast manner if the operating condition changes. For example, a set of different washers 26 may be manufactured for a predetermined set of operating conditions. This enables adaption of the wheel hub 2 to changes in the size and/or weight of the wheel, or changes in the expected forces acting on the wheel and/or flange 4 in an easy and fast way. Also, if the wheel hub 2 is used in a vehicle that runs on a predefined track, it may be possible to provide a washer 26 that is adapted to the specific loads and/or forces occurring on the predefined track.

The washer 26 may be made from the same material as the flange 4. For example, the washer 26 and the flange 4 may be made from a metal, such as steel, steel alloy, light metal, light alloy, carbon, and/or fiber reinforced materials. Alternatively, the washer 26 may be made from a different material than the flange 4. Furthermore, the reinforcement elements 18, 20, 22 may be integrally formed with the washer 26 or attached to the washer 26 by form-fitting, force-fitting and/or bonding, particularly by glueing, welding, screwing, bolting, and/or pressing or any other suitable fastening method.

To avoid any relative movement between the washer 26 and the flange 4, the washer 26 is fixed to the flange 4 by form-fitting, force-fitting and/or bonding, particularly by glueing, welding, screwing, bolting, and/or pressing or any other suitable fastening method.

In summary, by arranging at least one reinforcement element 18, 20, 22 at the flange 4 of the wheel hub 2, it is possible to counteract any bending moments that are induced in the flange 4 due to the loads and forces acting on the wheel hub 2 during an operation. This achieves a desired contact surface 28 for expected operating conditions and keeps the contact area between the wheel and the flange 4 as large as possible. Thus, the service life of the wheel hub or even any components adjacent to the wheel hub 2, such as a bearing, may be increased. Also, it may be possible to reduce noise and/or vibrations caused by movement of contacting parts, such as fretting noises.

By optimizing the flange contact surface 28 by using raised and lowered areas of the flange surface in specific areas of high and low load, the actual contact surface 28 under real operating conditions will generate a defined deforming of these raised and lowered flange areas to a planned surface contact area. By doing so, the maximum contact area between wheel and the flange 4 of the wheel hub 2 is provided under real running conditions.

Since the areas that are most affected by the loads acting on the flange 4 are reinforced with the at least one reinforcement element 18, 20, 22, it is also possible to reduce the material and/or size of the flange 4 in sections that are not affected or that are only slightly affected.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### REFERENCE NUMERALS

1 wheel hub bearing assembly
2 wheel hub
4 flange
6 hole
7 hole
8 first inner ring
10 bearing unit
12 second inner ring
14 outer ring
16 rolling element
18 reinforcement element
20 reinforcement element
22 reinforcement element
24 central opening
26 washer
28 contact surface

We claim:

1. A wheel hub assembly for a vehicle, the wheel hub assembly comprising:
a wheel hub including a flange configured to be connected to at least one wheel of the vehicle with at least one fastening means and at least one reinforcing element provided on the flange to increase a stiffness of the flange within a predetermined area, the predetermined area being determined based on at least one operating condition of the vehicle.

2. The wheel hub assembly according to claim 1, wherein the stiffness of the flange is increased by the reinforcement element such that a bending moment induced on the flange by a load is below a predefined threshold.

3. The wheel hub assembly according to claim 1, wherein the at least one reinforcement element is arranged in an area of the at least one fastening means.

4. The wheel hub assembly according to claim 1, wherein the flange has at least one contact surface configured to be connected to the at least one wheel, the at least one reinforcement element being located at the contact surface.

5. The wheel hub assembly according to claim 1, wherein the at least one reinforcing element includes a plurality of reinforcement elements, the plurality of reinforcement elements being arranged on the flange to minimize a variation in magnitude of bending moments applied over the entire flange.

6. The wheel hub assembly according to claim 1, further comprising a washer providing the at least one reinforcement element.

7. The wheel hub assembly according to claim 6, wherein the washer is fixed to flange by form-fitting, force-fitting and/or bonding.

8. The wheel hub assembly according to claim 1, wherein the at least one reinforcement element is integrally formed with the flange of the wheel hub or provided by a washer.

9. The wheel hub assembly according to claim 1, wherein the at least one reinforcement element is attached to the flange by form-fitting, force-fitting and/or bonding or provided on a washer attached to the flange by form-fitting, force-fitting and/or bonding.

10. The wheel hub assembly according to claim 1, wherein the at least one reinforcement element is made from a material different than a material of the flange.

11. A method for adapting a flange of a wheel hub of a vehicle to operating conditions of the vehicle, the flange being configured to be connected to at least one wheel of the vehicle by at least one fastening means, the method comprising the steps of:
determining an area on the flange at which a load acts on the flange under the operating conditions; and
adding at least one reinforcement element to the flange in the determined area on the flange to increase stiffness of the flange.

12. The method according to claim 11, further comprising a step of determining a bending moment induced in the flange based on a determined load;
wherein the step of determining the area of the flange at which the load acts on the flange includes determining a location at which the determined bending moment is above a predefined threshold; and
wherein the step of adding the at least one reinforcement element to the flange includes adding the reinforcement element at the location at which the determined bending moment is above the predetermined threshold.

13. The method according to claim 12, wherein the method further comprises the step of adapting a topology of the flange such that the bending moment induced by the determined load is below the predefined threshold in the determined area under operating conditions.
